(19) United States
(12) Patent Application Publication
(10) Pub. No.: US 2025/0357644 A1
(43) Pub. Date: Nov. 20, 2025

(54) METHOD OF MANUFACTURING POWER STORAGE DEVICE

(71) Applicant: Prime Planet Energy & Solutions, Inc., Tokyo (JP)

(72) Inventor: Hideaki YAMANAKA, Kusatsu-shi (JP)

(21) Appl. No.: 19/048,973

(22) Filed: Feb. 10, 2025

(30) Foreign Application Priority Data
May 16, 2024 (JP) 2024-080384

(51) Int. Cl. H01M 50/536; B23K 26/21

(52) U.S. Cl. CPC H01M 50/536; B23K 26/21

(57) ABSTRACT

A method of manufacturing a power storage device includes a laser welding process having a placement process of placing a part of an unwelded laminated current collector of an electrode body over space between a pair of elongate protrusions of an unwelded current collecting member, an adhesion process of pressing a pair of outer regions of the unwelded laminated current collector against the unwelded current collecting member to cause foil bridge portions of foil current collectors to adhere to each other, and a melting and solidifying process of melting a first region of the unwelded laminated current collector and a second region of the unwelded current collecting member while exhausting gas to the outside through a gas exhaust groove, and forming a melted and solidified portion.

### CROSS-REFERENCE TO RELATED APPLICATIONS

This application is based upon and claims the benefit of priority from the prior Japanese Patent Application No. 2024-080384 filed on May 16, 2024, the entire contents of which are incorporated herein by reference.

### BACKGROUND

### Technical Field

The disclosure relates to a method of manufacturing a power storage device including an electrode body having a laminated current collector, and a current collecting member to which the laminated current collector of the electrode body is welded and which is conductively connected to the laminated current collector.

### Related Art

As a power storage device, a battery is known which includes an electrode body having positive and negative electrode sheets, and positive and negative current collecting members conductively connected to the electrode body. Specifically, in the case where the electrode body is of laminate type, for example, the electrode body has a plurality of positive electrode sheets and a plurality of negative electrode sheets, and each of the positive and negative electrode sheets has a foil current collector where an electrode foil of the electrode sheet is exposed. The electrode body has a laminated current collector of the positive electrode in which the foil current collectors where the electrode foils of the electrode sheets of the positive electrode are exposed are laminated, and a laminated current collector of the negative electrode in which the foil current collectors where the electrode foils of the electrode sheets of the negative electrode are exposed are laminated. On the other hand, in the case where the electrode body is of flat wound type, the electrode body has a strip-shaped positive electrode sheet and a strip-shaped negative electrode sheet, and each of the positive and negative electrode sheets has a strip-shaped foil current collector where an electrode foil of the electrode sheet is exposed. The electrode body has a laminated current collector of the positive electrode in which the foil current collector of the positive electrode sheet is wound into a flat shape such that layers of the foil current collector are laminated, and a laminated current collector of the negative electrode in which the foil current collector of the negative electrode sheet is wound into a flat shape such that layers of the foil current collector are laminated. The laminated current collector of the positive electrode of the electrode body is welded to the current collecting member of the positive electrode, and the laminated current collector of the negative electrode of the electrode body is welded to the current collecting member of the negative electrode. Furthermore, in this type of battery, the current collecting member of the positive electrode is connected to a terminal of the positive electrode of the battery, and the current collecting member of the negative electrode is connected to a terminal of the negative electrode of the battery. Alternatively, the current collecting member of the positive electrode itself extends to the outside of the battery to provide the terminal of the positive electrode, and the current collecting member of the negative electrode itself extends to the outside of the battery to provide the terminal of the negative electrode.

In manufacturing the battery as described above, it is proposed to use laser welding to weld the laminated current collector of the electrode body and the current collecting member. Specifically, an unwelded laminated current collector before welding is superposed on an unwelded current collecting member before welding, and a laser beam is applied from above the unwelded laminated current collector to the unwelded laminated current collector, to melt and mix parts of the unwelded laminated current collector and the unwelded current collecting member. The melted part, i.e., the metal into which a part of the unwelded laminated current collector and a part of the unwelded current collecting member are melted and mixed, is then solidified to form a melted and solidified portion. In this manner, the laminated current collector is welded to the current collecting member. Related prior art documents include, for example, Japanese unexamined patent application publication No. 2019-067570 (JP 2019-067570 A).

### SUMMARY

### Technical Problems

However, it has been found that large or many blowholes are generated in the melted and solidified portion formed by welding. During laser welding, gas, such as air, remains between foil current collectors that form a first region to be melted with the laser beam, of the unwelded laminated current collector, and between the first region and a second region of the unwelded current collecting member that overlaps the first region. Therefore, it is considered that the gas becomes trapped in the melted and solidified portion during laser welding, and turns into blowholes.

The disclosure was made in view of the situation as described above, and provides a method of manufacturing a power storage device that can reduce or eliminate blowholes generated in a melted and solidified portion when an unwelded laminated current collector of an electrode body is laser-welded to an unwelded current collecting member.

### Means of Solving the Problems

(1) One aspect of the disclosure for solving the above problem is a method of manufacturing a power storage device including an electrode body having an electrode sheet including an electrode foil, the electrode body having a laminated current collector in which foil current collectors where the electrode foil of the electrode sheet is exposed are laminated in a lamination direction, the power storage device further including a current collecting member to which the laminated current collector of the electrode body is welded and which is conductively connected to the laminated current collector. The method includes a laser welding process of superposing an unwelded laminated current collector before welding on an unwelded current collecting member before welding in the lamination direction, melting and mixing a first region of the unwelded laminated current collector and a second region of the unwelded current collecting member that overlaps the first region through irradiation with a laser beam, and then solidifying a metal into which the first region and the second region are melted and mixed to form a melted and solidified portion and weld the laminated current collector to the current collecting member. The unwelded current collecting member has an opposed surface opposed to the unwelded laminated current collector, a pair of elongate protrusions that protrude from the opposed surface, and a gas exhaust groove formed between the elongate protrusions. The opposed surface includes a pair of outer opposed surface portions located on both outer sides of the pair of elongate protrusions in an arrangement direction in which the elongate protrusions are arranged. The laser welding process includes a placement process of placing a part of the unwelded laminated current collector over space between the elongate protrusions of the unwelded current collecting member, and providing the unwelded laminated current collector with a bridge region that spans the space between the elongate protrusions, and a pair of outer regions located on both outer sides in the arrangement direction of the bridge region and superposed on the pair of outer opposed surface portions of the unwelded current collecting member, an adhesion process of pressing the pair of outer regions of the unwelded laminated current collector against the pair of outer opposed surface portions of the unwelded current collecting member, pressing a pair of bridge end portion on one side and the other side in the arrangement direction of the bridge region against the elongate protrusions, respectively, and applying tension in the arrangement direction to foil bridge portions included in the bridge region as part of the respective foil current collectors that form the unwelded laminated current collector, to cause the foil bridge portions to adhere to each other in the lamination direction, and a melting and solidifying process of melting the first region comprising at least a part of the bridge region of the unwelded laminated current collector and the second region comprising at least a part of each of the elongate protrusions of the unwelded current collecting member, while exhausting gas generated from the first region and the second region to an outside through the gas exhaust groove, and then forming the melted and solidified portion.

In the method of manufacturing the power storage device described above, the pair of elongate protrusions that form the gas exhaust groove are provided in advance on the unwelded current collecting member before welding. Then, in the adhesion process as part of the laser welding process, the pair of outer regions of the unwelded laminated current collector are pressed against the pair of outer opposed surface portions of the opposed surface of the unwelded current collecting member, and the pair of bridge end portions of the bridge region are respectively pressed against the elongate protrusions. At the same time, tension is applied in the arrangement direction to the foil bridge portions included in the bridge region as part of the respective foil current collectors that form the unwelded laminated current collector, so that the foil bridge portions adhere to each other in the lamination direction. Therefore, gas present in the bridge region of the unwelded laminated current collector can be reduced. Then, in the melting and solidifying process, the first region comprising at least a part of the bridge region of the unwelded laminated current collector and the second region comprising at least a part of each of the elongate protrusions of the unwelded current collecting member are melted, and, after gas generated from the first and second regions is exhausted from the gas exhaust groove to the outside, the melted and solidified portion is formed. Thus, blowholes are less likely or unlikely to be generated in the melted and solidified portion.

Examples of the “power storage device” include secondary batteries, such as a lithium-ion secondary battery, sodium-ion secondary battery, and a calcium-ion secondary battery, and capacitors, such as a lithium-ion capacitor.

The “pair of elongate protrusions” may partially remain in the current collecting member after laser welding, or the pair of elongate protrusions may not be present in the current collecting member after laser welding due to the formation of the melted and solidified portion by laser welding. Also, the “gas exhaust groove” may partially remain in the current collecting member after laser welding, or the gas exhaust groove may not be present in the current collecting member after laser welding due to the formation of the melted and solidified portion by laser welding.
(2) In the method of manufacturing the power storage device described in (1) above, the pair of elongate protrusions of the unwelded current collecting member each may have a flat top surface, and the pair of bridge end portions of the bridge region of the unwelded laminated current collector may be respectively pressed against the flat top surfaces of the pair of elongate protrusions in the adhesion process.

In the method of manufacturing the power storage device described above, the elongate protrusions of the unwelded current collecting member have flat top surfaces, and the pair of bridge end portions of the bridge region of the unwelded laminated current collector are pressed against the flat top surfaces in the adhesion process. Therefore, damages, such as cracks, can be surely prevented from occurring in portions of the foil current collectors that form the bridge end portions when pressed against the elongate protrusions.
(3) In the method of manufacturing the power storage device described in (1) or (2) above, the pair of outer opposed surface portions of the unwelded current collecting member each may be a flat surface, and the pair of outer regions of the unwelded laminated current collector may be pressed at a pair of flat pressing surfaces of pressing jigs against the pair of outer opposed surface portions as the flat surfaces of the unwelded current collecting member in the adhesion process.

In the method of manufacturing the power storage device described above, the outer opposed surface portions of the unwelded current collecting member are flat surfaces, and the pair of outer regions of the unwelded laminated current collector are pressed at the flat pressing surfaces of the pressing jigs against the pair of flat outer opposed surface portions of the unwelded current collecting member in the adhesion process. Therefore, the outer regions can be properly pressed against the outer opposed surface portions of the unwelded current collecting member without causing damages, such as cracks, to be generated in the portions of the foil current collectors that form the outer regions.

### BRIEF DESCRIPTION OF THE DRAWINGS

FIG. 1 is a perspective view of a battery according to one embodiment;

FIG. 2 is a partial cross-sectional view of the battery according to the embodiment, taken along the battery height direction and the battery width direction;

FIG. 3 is a cross-sectional view of the battery according to the embodiment as seen in the direction of arrows in FIG. 2, taken along the battery height direction and the battery thickness direction;

FIG. 4 is a flowchart of a method of manufacturing the battery according to the embodiment;

FIG. 5 is an explanatory view as seen from above, showing an unwelded laminated current collector of an electrode body superposed on an unwelded current collecting member and pressing jigs further superposed on the unwelded laminated current collector to press the unwelded laminated current collector, in connection with the method of manufacturing the battery according to the embodiment;

FIG. 6 is a cross-sectional view as seen in the direction of arrows in FIG. 5, showing the unwelded laminated current collector of the electrode body superposed on the unwelded current collecting member and the pressing jigs further superposed on the unwelded laminated current collector to press the unwelded laminated current collector, in connection with the method of manufacturing the battery according to the embodiment;

FIG. 7 is an explanatory view showing the manner of applying a laser beam to the unwelded laminated current collector while pressing the unwelded laminated current collector against the unwelded current collecting member, in connection with the method of manufacturing the battery according to the embodiment;

FIG. 8 is an explanatory view showing a melted and solidified portion formed by laser welding, in connection with the method of manufacturing the battery according to the embodiment; and

FIG. 9 is an explanatory view showing positive and negative laminated current collectors of the electrode body connected to positive and negative current collecting members, in connection with the method of manufacturing the battery according to the embodiment.

### DETAILED DESCRIPTION OF THE EXEMPLARY EMBODIMENTS

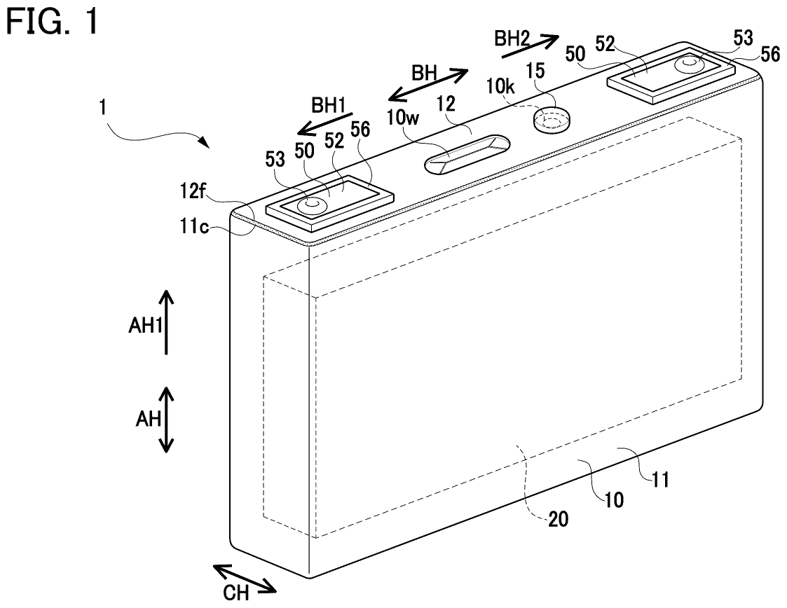

In the following, one embodiment of the disclosure will be described with reference to the drawings. A battery (one example of the power storage device of the disclosure) 1 of the embodiment is a sealed lithium-ion secondary battery of a rectangular (rectangular parallelepiped) shape, which is installed on a vehicle, such as a hybrid vehicle, plug-in hybrid vehicle, or an electric vehicle. In the following description, the battery height direction AH, battery width direction BH, and battery thickness direction CH of the battery 1 are defined as the directions indicated in FIG. 1 to FIG. 3. The battery 1 consists of a case 10, an electrode body 20 and electrolyte 5 housed in the case 10, positive and negative terminals 50 respectively supported by the case 10, and so forth (see FIG. 1 to FIG. 3). A laminated current collector 30 of the positive electrode of the electrode body 20 is connected to the terminal 50 of the positive electrode via a current collecting member 40 of the positive electrode, and the laminated current collector 30 of the negative electrode of the electrode body 20 is connected to the terminal 50 of the negative electrode via the current collecting member 40 of the negative electrode. In the case 10, the electrode body 20 is covered with a bag-shaped insulating holder 7 formed from an insulating film.

The case 10 is shaped like a rectangular parallelepiped box and made of metal (aluminum in the embodiment). The case 10 consists of a case body 11 and a case lid member 12. The case body 11 is in the form of a rectangular tube with a bottom and a rectangular or frame-like opening portion 11c and houses the electrode body 20 therein. The case lid member 12 is in the form of a rectangular plate that closes an opening of the case body 11 that is defined by the opening portion 11c. The opening portion 11c of the case body 11 and a peripheral portion 12f of the case lid member 12 are hermetically welded together over the entire circumference thereof. The case lid member 12 is provided with a safety valve 10w that fractures and opens when the internal pressure of the case 10 exceeds the valve opening pressure. The case lid member 12 is also provided with a liquid inlet 10k, and the liquid inlet 10k is hermetically sealed with a disc-shaped sealing member 15 made of aluminum.

Insertion holes 10h are respectively provided in portions of the case lid member 12 near its ends on one side BH1 and the other side BH2 in the battery width direction BH. The terminal 50 of the positive electrode made of aluminum is inserted through the insertion hole 10h on the one side BH1, and the terminal 50 of the negative electrode made of copper is inserted through the insertion hole 10h on the other side BH2. Since the positive and negative terminals 50 have substantially the same configuration, the same reference numeral is assigned to the terminals 50, which will be described collectively below. Each of the terminals 50 is fixed to the case lid member 12 via an internal insulating member 55 placed inside the case 10 and an external insulating member 56 placed outside the case 10 and in the insertion hole 10h.

Each of the terminals 50 consists of an internal terminal member 51, an external terminal member 52, and a crimped terminal member 53. The internal terminal member 51 is in the form of a rectangular plate extending in the battery width direction BH and the battery thickness direction CH, and is located inside the case 10. The external terminal member 52 is in the form of a rectangular plate extending in the battery width direction BH and the battery thickness direction CH, and is located outside the case 10. The crimped terminal member 53 is inserted through the insertion hole 10h, and further extends through the internal terminal member 51 and the external terminal member 52, to be crimped and connected to the internal terminal member 51 and the external terminal member 52. The current collecting member 40 of the positive electrode that will be described below is welded to the internal terminal member 51 of the terminal 50 of the positive electrode, and the current collecting member 40 of the negative electrode is welded to the internal terminal member 51 of the terminal 50 of the negative electrode.

Next, the electrode body 20 will be described. The electrode body 20 is of a rectangular parallelepiped, laminate type, and has a plurality of electrode sheets 21 of the positive electrode and a plurality of electrode sheets 21 of the negative electrode alternately laminated via separators 24 in the form of porous resin films. Each of the positive and negative electrode sheets 21 and the separators 24 has a rectangular shape extending in the battery height direction AH and the battery width direction BH. Since the positive and negative electrode sheets 21 have substantially the same configuration, the same reference numeral is assigned to the electrode sheets 21, which will be collectively described below.

The electrode sheet 21 consists of a rectangular electrode foil 22 (aluminum foil for the positive electrode and copper foil for the negative electrode), and active material layers 23 including active material particles and respectively formed on both main surfaces of the electrode foil 22. A part of the electrode foil 22 extends to the upper side AH1 in the battery height direction AH. The extended part of the electrode foil 22 is exposed without the active material layers 23 present on both of its main surfaces, and provides a foil current collector 21r of the electrode sheet 21. The portions of the electrode sheets 21 that have the active material layers 23 on the electrode foils 22 are laminated via the separators 24, to form a main body 25 of the electrode body 20. On the other hand, the foil current collectors 21r of the electrode sheets 21 are laminated in a lamination direction SH, to form the laminated current collector 30 that connects to the main body 25 of the electrode body 20. The laminated current collector 30 of the positive electrode is welded at its distal end portion to the current collecting member 40 of the positive electrode, and is conductively connected to the current collecting member 40. The laminated current collector 30 of the negative electrode is welded at its distal end portion to the current collecting member 40 of the negative electrode, and is conductively connected to the current collecting member 40.

The current collecting member 40 of the positive electrode is made of aluminum, and the current collecting member 40 of the negative electrode is made of copper. Since the positive and negative current collecting members 40 have substantially the same configuration, the same reference numeral is assigned to the current collecting members 40, which will be collectively described below. The current collecting member 40 is in the form of a rectangular plate extending in the battery width direction BH and the battery thickness direction CH. The current collecting member 40 of the positive electrode is welded at its end portion on one side BH1 in the battery width direction BH to the internal terminal member 51 of the terminal 50 of the positive electrode, and is conductively connected to the terminal 50 of the positive electrode. On the other hand, the current collecting member 40 of the negative electrode is welded at its end portion on the other side BH2 in the battery width direction BH to the internal terminal member 51 of the terminal 50 of the negative electrode, and is conductively connected to the terminal 50 of the negative electrode.

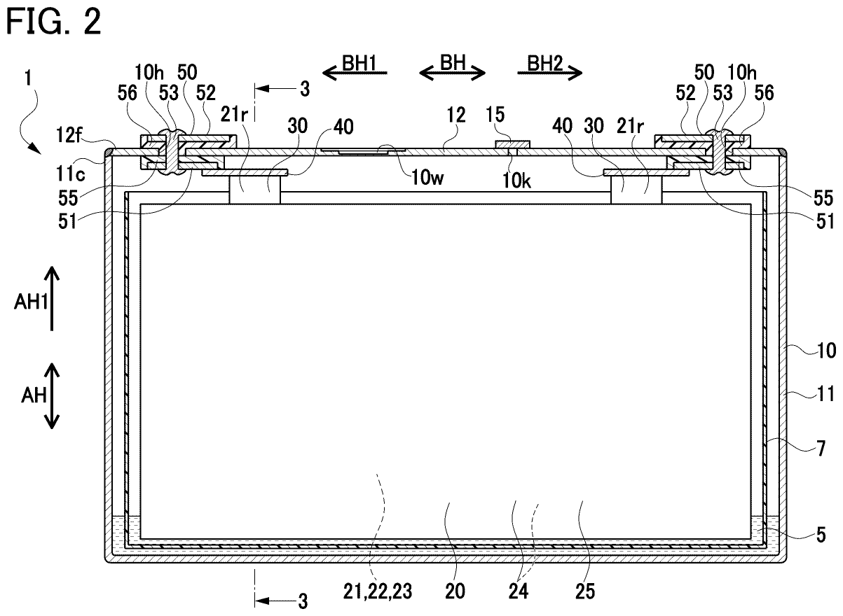

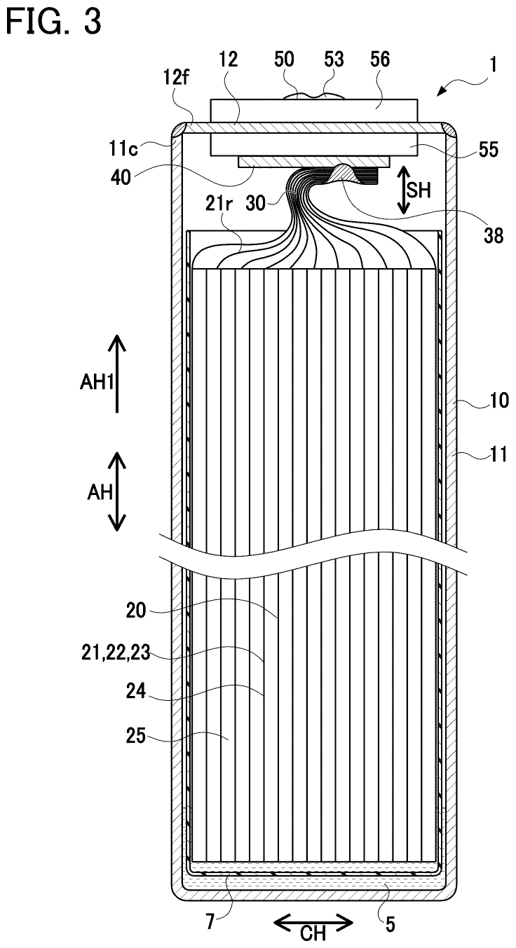

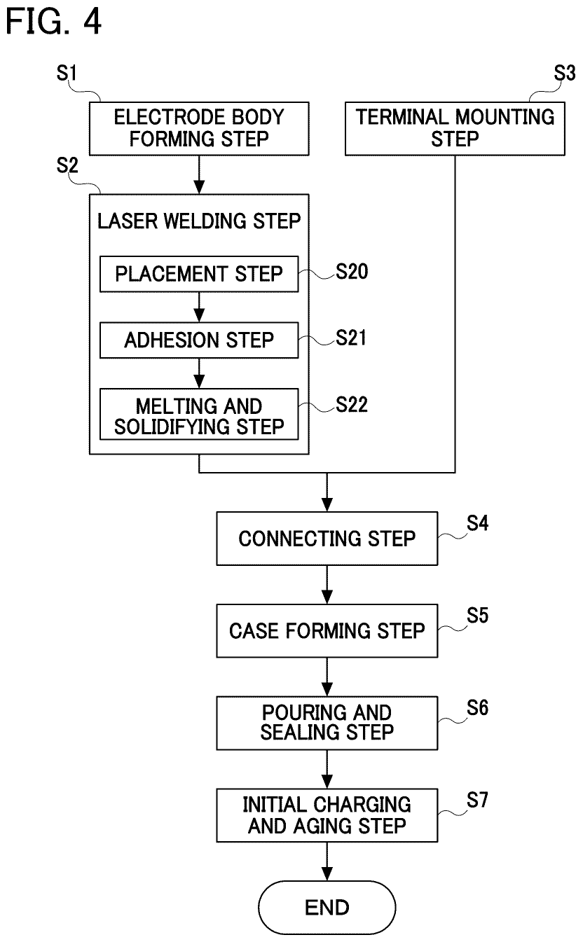

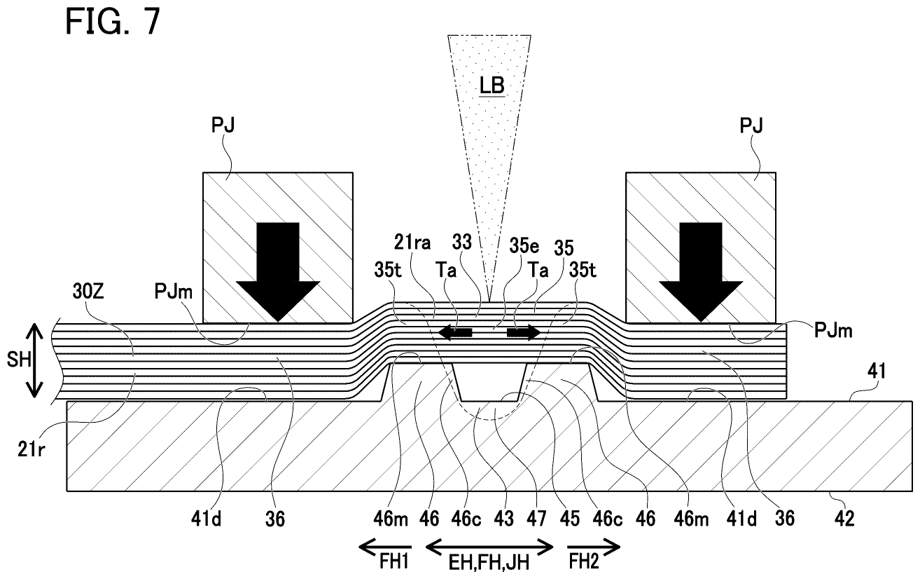

Next, a method of manufacturing the battery 1 described above will be described (see FIG. 4 to FIG. 9). First, in an electrode body forming step S1 (see FIG. 4), the electrode body 20 is formed. Specifically, a plurality of electrode sheets 21 of the positive electrode, a plurality of electrode sheets 21 of the negative electrode, and a plurality of separators 24, each having a rectangular shape, are prepared. Then, the electrode sheets 21 of the positive electrode and the electrode sheets 21 of the negative electrode are alternately laminated with the separators 24 sandwiched between the positive and negative electrode sheets 21, to form the electrode body 20 (see FIG. 2 and FIG. 3).

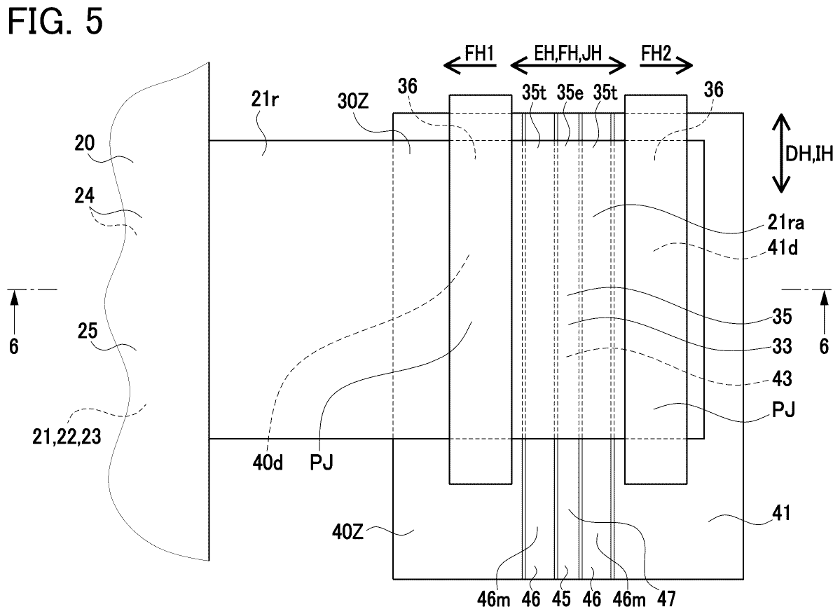

Then, in a laser welding step S2 (see FIG. 4), unwelded current collecting members 40Z of the positive and negative electrodes before welding are prepared, and an unwelded laminated current collector 30Z of the positive electrode before welding as part of the electrode body 20 is laser-welded to the unwelded current collecting member 40Z of the positive electrode, while an unwelded laminated current collector 30Z of the negative electrode before welding as part of the electrode body 20 is laser-welded to the unwelded current collecting member 40Z of the negative electrode (see FIG. 5 to FIG. 9).

The unwelded laminated current collector 30Z of the electrode body 20 is in the form of a rectangular plate that extends in an extension direction JH (the lateral direction in FIG. 5 to FIG. 9) from the main body 25 of the electrode body 20. In this embodiment, the thickness of the unwelded laminated current collector 30Z when pressed in the lamination direction SH is 1.0 mm.

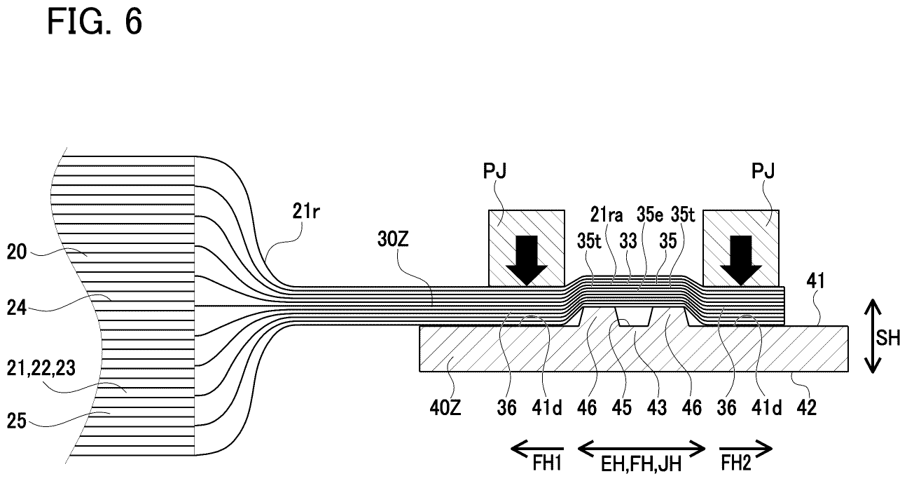

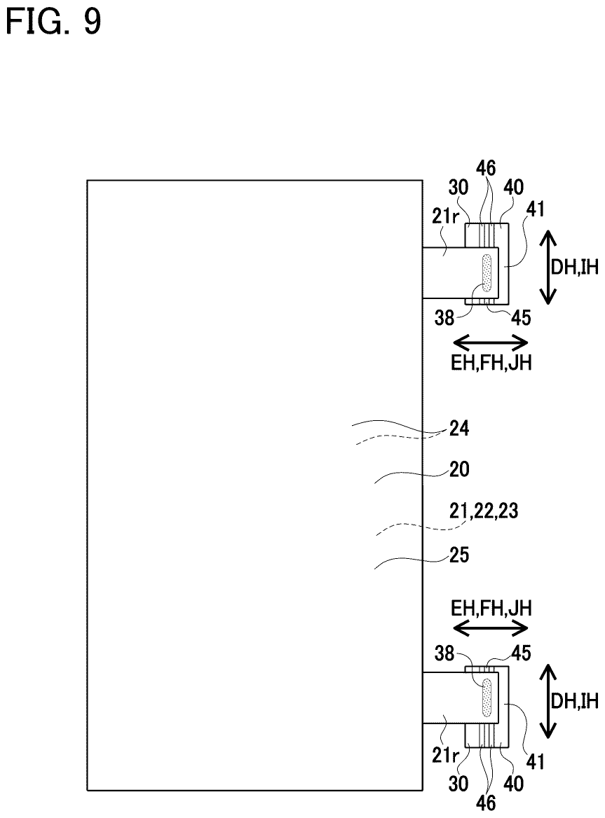

The unwelded current collecting member 40Z is in the form of a rectangular plate extending in a first direction DH (the vertical direction in FIG. 5 and FIG. 9, the direction perpendicular to the plane of paper in FIG. 6 to FIG. 8) and a second direction EH (the lateral direction in FIG. 5 to FIG. 9) perpendicular to the first direction DH. The unwelded current collecting member 40Z has a flat opposed surface 41 opposed to the unwelded laminated current collector 30Z during welding, and a flat rear surface 42 that is parallel to the opposed surface 41 and is located opposite to the opposed surface 41. In this embodiment, the thickness of the unwelded current collecting member 40Z measured from the opposed surface 41 to the rear surface 42 is 1.0 mm. In this embodiment, in a condition where the unwelded laminated current collector 30Z is superposed on the unwelded current collecting member 40Z, the first direction DH of the unwelded current collecting member 40Z is the same as an orthogonal direction IH (the vertical direction in FIG. 5 and FIG. 9, the direction perpendicular to the plane of paper in FIG. 6 to FIG. 8) of the unwelded laminated current collector 30Z, and the second direction EH of the unwelded current collecting member 40Z is the same as the extension direction JH of the unwelded laminated current collector 30Z.

The unwelded current collecting member 40Z has a pair of elongate protrusions 46 that protrude from the opposed surface 41. The elongate protrusions 46 are spaced at a predetermined distance, and respectively extend in the first direction DH from one end in the first direction DH of the unwelded current collecting member 40Z to the other end, in a middle portion of the unwelded current collecting member 40Z as viewed in the second direction EH. Each of the elongate protrusions 46 has a flat top surface 46m. In this embodiment, the dimensions of each elongate protrusion 46 are as follows: the width (the dimension measured in the second direction EH) at the level of the opposed surface 41 is 1.3 mm, the height is 0.5 mm, and the length (the dimension measured in the first direction DH) is 5.0 mm.

A gas exhaust groove 45 is formed between the elongate protrusions 46. The gas exhaust groove 45 extends in the first direction DH from one end in the first direction DH of the unwelded current collecting member 40Z to the other end, along the elongate protrusions 46, in a middle portion of the unwelded current collecting member 40Z as viewed in the second direction EH. In this embodiment, the dimensions of the gas exhaust groove 45 are as follows: the width at the level of the opposed surface 41, that is, the width of the bottom (the dimension measured in the second direction EH) is 0.4 mm, the depth of 0.5 mm, and the length (the dimension measured in the first direction DH) is 5.0 mm.

The opposed surface 41 of the unwelded current collecting member 40Z includes a pair of outer opposed surface portions 41d located on both outer sides in an arrangement direction FH (that is the same as the second direction EH in this embodiment) of the pair of elongate protrusions 46. Each of the outer opposed surface portions 41d is a flat surface, and extends along the elongate protrusion 46 in the first direction DH from one end in the first direction DH of the unwelded current collecting member 40Z to the other end.

In the laser welding step S2, a placement step S20, an adhesion step S21, and a melting and solidifying step S22 are carried out in this order (see FIG. 4).

In the placement step S20, the unwelded laminated current collector 30Z is superposed on the opposed surface 41 of the unwelded current collecting member 40Z in the lamination direction SH, such that a part of the unwelded laminated current collector 30Z is placed over space between the elongate protrusions 46 of the unwelded current collecting member 40Z. Thus, the unwelded laminated current collector 30Z is provided with a bridge region 35 that spans the space between the elongate protrusions 46, and a pair of outer regions 36 located on both outer sides in the arrangement direction FH of the bridge region 35 and superposed on the pair of outer opposed surface portions 41d of the opposed surface 41 of the unwelded current collecting member 40Z (see FIG. 5 to FIG. 7).

Then, in the adhesion step S21, a pair of pressing jigs PJ are further superposed on the pair of outer regions 36 of the unwelded laminated current collector 30Z. Each of the pressing jigs PJ has a rectangular parallelepiped shape and has a flat pressing surface PJm. Then, the pair of outer regions 36 of the unwelded laminated current collector 30Z are respectively pressed with the pair of pressing jigs PJ against the pair of outer opposed surface portions 41d of the opposed surface 41 of the unwelded current collecting member 40Z. Then, a pair of bridge end portion 35t on one side FH1 and the other side FH2 in the arrangement direction FH of the bridge region 35 of the unwelded laminated current collector 30Z are respectively pressed against the elongate protrusions 46. At the same time, tension Ta is applied in the arrangement direction FH to foil bridge portions 21ra included in the bridge region 35 as part of the respective foil current collectors 21r that form the unwelded laminated current collector 30Z, so that the foil bridge portions 21ra adhere to each other in the lamination direction SH.

As a result, gas present in the bridge region 35 of the unwelded laminated current collector 30Z is reduced. The pressing jigs PJ have the flat pressing surfaces PJm, and, in the adhesion step S21, the outer regions 36 of the unwelded laminated current collector 30Z are pressed at the flat pressing surfaces PJm against the flat outer opposed surface portions 41d of the unwelded current collecting member 40Z. In addition, the elongate protrusions 46 have the flat top surfaces 46m, and, in the adhesion step S21, the bridge end portions 35t of the bridge region 35 are pressed against the flat top surfaces 46m.

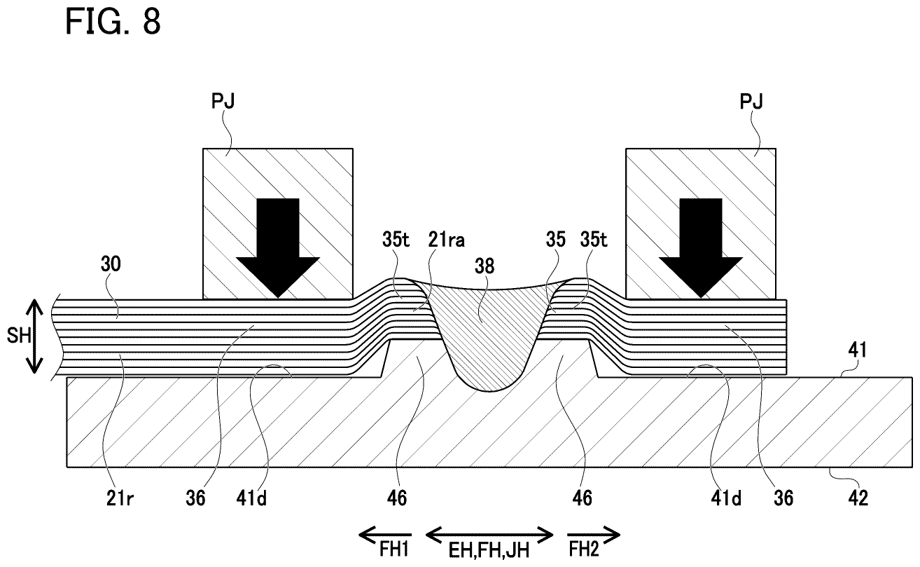

Subsequently, in the melting and solidifying step S22, a laser beam LB is applied from above the unwelded laminated current collector 30Z to a first region 33 of the unwelded laminated current collector 30Z, to melt and mix the first region 33 and a second region 43 of the unwelded current collecting member 40Z that overlaps the first region 33. The metal into which the first region 33 and the second region 43 are melted and mixed is then solidified to form a melted and solidified portion 38 so that the laminated current collector 30 is welded to the current collecting member 40 (see FIG. 8 and FIG. 9). In this embodiment, YAG laser is used.

In this embodiment, the first region 33 to be melted with the laser beam LB as part of the unwelded laminated current collector 30Z is a middle portion 35e of the bridge region that excludes its portions near both ends in the arrangement direction FH. The first region 33 (middle portion 35e) extends in the orthogonal direction IH, and covers the entire thickness of the unwelded laminated current collector 30Z in the lamination direction SH.

The second region 43 to be melted with the laser beam LB as part of the unwelded current collecting member 40Z is a portion of the unwelded current collecting member 40Z that overlaps the first region 33 of the unwelded laminated current collector 30Z and extends in the first direction DH. The second region 43 consists of inner portions 46c in the arrangement direction FH of the respective elongate protrusions 46 and a bottom portion 47 that defines the bottom of the gas exhaust groove 45.

The first region 33 and the second region 43 are melted and mixed, and the melted metal is then solidified to form the melted and solidified portion 38 having a width (dimension in the extension direction JH and the second direction EH) of 2.0 mm and a length (dimension in the orthogonal direction IH and the first direction DH) of 4.0 mm. In this embodiment, parts of the elongate protrusions 46 are left in the current collecting member 40 after laser welding. On the other hand, the gas exhaust groove 45 except both end portions in the first direction DH is eliminated due to the formation of the melted and solidified portion 38 by laser welding.

In the laser welding, the first region 33 of the unwelded laminated current collector 30Z and the second region 43 of the unwelded current collecting member 40Z are melted, and gas generated from the first and second regions 33, 43 is exhausted to the outside through the gas exhaust groove 45. Then, the melted and solidified portion 38 is formed. Therefore, blowholes are less likely or unlikely to be generated in the melted and solidified portion 38. Since the gas exhaust groove 45 extends in the first direction DH, the gas is exhausted to the outside from both sides in the first direction DH of the gas exhaust groove 45.

Meanwhile, in a terminal mounting step S3 (see FIG. 4), the case lid member 12 is prepared, and the positive and negative terminals 50 are fixed to the case lid member 12 (see FIG. 1 to FIG. 3). Specifically, the internal terminal member 51, external terminal member 52, crimped terminal member 53, internal insulating member 55, and external insulating member 56 of the positive electrode are prepared. Then, the internal insulating member 55 and the external insulating member 56 are placed at predetermined positions of the case lid member 12, and the internal terminal member 51, external terminal member 52, and crimped terminal member 53 are placed in position. The crimped terminal member 53 is crimped so that the terminal 50 of the positive electrode that consists of the internal terminal member 51, external terminal member 52, and crimped terminal member 53 is formed, and the terminal 50 of the positive electrode is fixed to the case lid member 12 while being insulted therefrom. The terminal 50 of the negative electrode is also formed in the same manner as the terminal 50 of the positive electrode.

Then, in a connecting step S4 (see FIG. 4), the positive and negative current collecting members 40 connected to the electrode body 20 in the laser welding step S2 are connected to the positive and negative terminals 50 supported by the case lid member 12. Specifically, part of the current collecting member 40 of the positive electrode is superposed on part of the internal terminal member 51 of the terminal 50 of the positive electrode, and a laser beam is applied to the current collecting member 40 from above the current collecting member 40, so that the current collecting member 40 is laser-welded to the internal terminal member 51. Similarly, the current collecting member 40 of the negative electrode is laser-welded to the internal terminal member 51 of the negative electrode. The electrode body 20 is then wrapped with the bag-like insulating holder 7.

Then, in a case forming step S5 (see FIG. 4), the case body 11 is prepared, the electrode body 20 covered with the insulating holder 7 is inserted into the case body 11, and the opening of the case body 11 is closed with the case lid member 12. Then, the opening portion 11c of the case body 11 and the peripheral portion 12f of the case lid member 12 are laser-welded hermetically over the entire circumference so that the case 10 is formed.

Then, in a pouring and sealing step S6, the electrolyte 5 is poured into the case 10 through the liquid inlet 10k, so that the electrode body 20 is impregnated with the electrolyte 5. Then, the liquid inlet 10k is hermetically sealed with the sealing member 15.

Then, in an initial charging and aging step S7, initial charging is performed on the battery 1. Then, the battery 1 is left to stand for a predetermined time so that the battery 1 is aged. In this manner, the battery 1 is completed.

In the method of manufacturing the battery 1 of this embodiment, the pair of elongate protrusions 46 that form the gas exhaust groove 45 are provided in advance on the unwelded current collecting member 40Z before welding. Then, in the adhesion step S21 of the laser welding step S2, the pair of outer regions 36 of the unwelded laminated current collector 30Z are pressed against the pair of outer opposed surface portions 41d of the opposed surface 41 of the unwelded current collecting member 40Z, and the pair of bridge end portions 35t of the bridge region 35 are respectively pressed against the elongate protrusions 46. At the same time, tension Ta is applied in the arrangement direction FH to the foil bridge portions 21ra included in the bridge region 35 as part of the foil current collectors 21r that form the unwelded laminated current collector 30Z, so that the foil bridge portions 21ra adhere to each other in the lamination direction SH. Therefore, the gas present in the bridge region 35 of the unwelded laminated current collector 30Z can be reduced. Then, in the melting and solidifying step S22, the first region 33, which comprises at least a part of the bridge region 35 of the unwelded laminated current collector 30Z, and the second region 43, which comprises at least parts of the respective elongate protrusions 46 of the unwelded current collecting member 40Z, are melted, and, after the gas generated from the first and second regions 33, 43 is exhausted from the gas exhaust groove 45 to the outside, the melted and solidified portion 38 is formed. Thus, the possibility of generation of blowholes in the melted and solidified portion 38 can be reduced or eliminated.

Furthermore, in this embodiment, the pair of elongate protrusions 46 of the unwelded current collecting member 40Z have the flat top surfaces 46m, and, in the adhesion step S21, the pair of bridge end portions 35t of the bridge region 35 of the unwelded laminated current collector 30Z are pressed against the flat top surfaces 46m. Therefore, damages, such as cracks, can be surely prevented from occurring in portions of the foil current collectors 21r that provide the bridge end portions 35t, when pressed against the elongate protrusions 46.

Also, in this embodiment, the pair of outer opposed surface portions 41d of the unwelded current collecting member 40Z are flat surfaces, and, in the adhesion step S21, the pair of outer regions 36 of the unwelded laminated current collector 30Z are pressed at the flat pressing surfaces PJm of the pressing jigs against the pair of flat outer opposed surface portions 41d of the unwelded current collecting member 40Z. Therefore, the outer regions 36 can be properly pressed against the outer opposed surface portions 41d of the unwelded current collecting member 40Z without causing damages, such as cracks, to be generated in the portions of the foil current collectors 21r that provide the outer regions 36.

While the disclosure has been described in the light of the embodiment, it is to be understood that the disclosure is not limited to the embodiment, but may be applied by making changes as needed, without departing from the principle of the disclosure.

In the embodiment, the battery 1 including a single electrode body 20 is illustrated by way of example. However, the battery is not limited to this type, but may include two or more electrode bodies. In this case, two or more pairs of positive and negative current collecting members may be prepared, and positive and negative laminated current collectors may be welded to the positive and negative current collecting members for each electrode body. Alternatively, one positive current collecting member and one negative current collecting member may be prepared, and two or more laminated current collectors of the positive electrode may be welded to the one current collecting member of the positive electrode, while two or more laminated current collectors of the negative electrode may be welded to the one current collecting member of the negative electrode.

In the embodiment, the laminate-type electrode body is illustrated by way of example as the electrode body. However, the electrode body is not limited to this type, but may be of a flat wound type in which positive and negative strip-shaped electrode sheets are wound into a flat shape via a pair of strip-shaped separators.

In the embodiment, the laser welding step S2 is carried out using the YAG laser. However, the laser is not limited to this type, but a fiber laser, disk laser, blue laser, green laser, etc. may be used as appropriate.

In the embodiment, the battery 1 is illustrated by way of example in which the current collecting member 40 of the positive electrode is connected to the terminal 50 of the positive electrode of the battery 1, and the current collecting member 40 of the negative electrode is connected to the terminal 50 of the negative electrode of the battery 1. However, the battery is not limited to this type. For example, the current collecting member of the positive electrode itself may extend to the outside of the battery and provides a positive terminal of the battery, and the current collecting member of the negative electrode itself may extend to the outside of the battery and provides a negative terminal of the battery.

### REFERENCE SIGNS LIST

1 Battery (Power storage device)
10 Case
20 Electrode body
21 Electrode sheet
21r Foil current collector
21ra Foil bridge portion
22 Electrode foil
30 Laminated current collector
30Z Unwelded laminated current collector
33 First region
35 Bridge region
35t Bridge end portion
36 Outer region
38 Melted and solidified portion
40 Current collecting member
40Z Unwelded current collecting member
41 Opposed surface
41d Outer opposed surface portion
43 Second region
45 Gas exhaust groove
46 Elongate protrusion
46m Flat top surface
50 Terminal
FH Arrangement direction (of elongate protrusions)
FH1 One side (in arrangement direction)
FH2 The other side (in arrangement direction)
SH Lamination direction (of laminated current collector)
PJ Pressing jig
PJm Pressing surface
Ta Tension
S2 Laser welding step
S20 Placement step
S21 Adhesion step
S22 Melting and solidifying step

What is claimed is:

1. A method of manufacturing a power storage device including an electrode body having an electrode sheet including an electrode foil, the electrode body having a laminated current collector in which foil current collectors where the electrode foil of the electrode sheet is exposed are laminated in a lamination direction, the power storage device further including a current collecting member to which the laminated current collector of the electrode body is welded and which is conductively connected to the laminated current collector, the method comprising laser welding including
superposing an unwelded laminated current collector before welding on an unwelded current collecting member before welding in the lamination direction, and
melting and mixing a first region of the unwelded laminated current collector and a second region of the unwelded current collecting member that overlaps the first region through irradiation with a laser beam, and then solidifying a metal into which the first region and the second region are melted and mixed to form a melted and solidified portion and weld the laminated current collector to the current collecting member,
wherein the unwelded current collecting member has an opposed surface opposed to the unwelded laminated current collector, a pair of elongate protrusions that protrude from the opposed surface, and a gas exhaust groove formed between the elongate protrusions,
wherein the opposed surface includes a pair of outer opposed surface portions located on both outer sides of the pair of elongate protrusions in an arrangement direction in which the elongate protrusions are arranged,
wherein the laser welding includes
placing a part of the unwelded laminated current collector over space between the elongate protrusions of the unwelded current collecting member, and providing the unwelded laminated current collector with a bridge region that spans the space between the elongate protrusions, and a pair of outer regions located on both outer sides in the arrangement direction of the bridge region and superposed on the pair of outer opposed surface portions of the unwelded current collecting member,
pressing the pair of outer regions of the unwelded laminated current collector against the pair of outer opposed surface portions of the unwelded current collecting member, pressing a pair of bridge end portion on one side and the other side in the arrangement direction of the bridge region against the elongate protrusions, respectively, and applying tension in the arrangement direction to foil bridge portions included in the bridge region as part of the respective foil current collectors that form the unwelded laminated current collector, to cause the foil bridge portions to adhere to each other in the lamination direction, and
melting the first region comprising at least a part of the bridge region of the unwelded laminated current collector and the second region comprising at least a part of each of the elongate protrusions of the unwelded current collecting member, while exhausting gas generated from the first region and the second region to an outside through the gas exhaust groove, and then forming the melted and solidified portion.

2. The method of manufacturing the power storage device according to claim 1, wherein:
the pair of elongate protrusions of the unwelded current collecting member each has a flat top surface; and
the pair of bridge end portions of the bridge region of the unwelded laminated current collector are respectively pressed against the flat top surfaces of the pair of elongate protrusions.

3. The method of manufacturing the power storage device according to claim 1, wherein:
the pair of outer opposed surface portions of the unwelded current collecting member each is a flat surface; and
the pair of outer regions of the unwelded laminated current collector are pressed at a pair of flat pressing surfaces of pressing jigs against the pair of outer opposed surface portions as the flat surfaces of the unwelded current collecting member.

4. The method of manufacturing the power storage device according to claim 2, wherein:
the pair of outer opposed surface portions of the unwelded current collecting member each is a flat surface; and
the pair of outer regions of the unwelded laminated current collector are pressed at a pair of flat pressing surfaces of pressing jigs against the pair of outer opposed surface portions as the flat surfaces of the unwelded current collecting member.
